(19) United States
(12) Patent Application Publication
(10) Pub. No.: US 2014/0379719 A1
(43) Pub. Date: Dec. 25, 2014

(54) System and method for tagging and searching documents

(71) Applicant: TENCENT TECHNOLOGY (SHENZHEN) COMPANY LIMITED, Shenzhen (CN)

(72) Inventor: Jiaqiang Wang, Shenzhen (CN)

(21) Appl. No.: 14/329,353

(22) Filed: Jul. 11, 2014

Related U.S. Application Data
(63) Continuation of application No. PCT/CN2014/077405, filed on May 13, 2014.

(30) Foreign Application Priority Data
Jun. 24, 2013 (CN) 2013102548514

(51) Int. Cl. G06F 17/30

(52) U.S. Cl. CPC G06F 17/30011; G06F 17/30705
USPC 707/738

(57) ABSTRACT

System, method and computer-readable medium allow tagging and searching documents. A plurality of electronically stored documents are combined into a group. For each of the plurality of documents in the group, a word set corresponding to the document is obtained by performing word-segmentation on the document, the obtained word set including a plurality of words contained in the document. The obtained word sets is aggregated into a subject set including a plurality of subjects, each subject including a plurality of subject words. For each of the plurality of subjects in the subject set, a subject word is selected among the plurality of subject words as an attribute word of the subject. For each of the plurality of documents in the group which contains one or more of the plurality of attribute words, the document is associated with at least a portion of the one or more attribute words. Other embodiments of this aspect include corresponding systems and computer program products.

### CROSS REFERENCE TO RELATED APPLICATIONS

This is a continuation application of International Patent Application No. PCT/CN2014/077405, filed on May 13, 2014, which claims priority to Chinese Patent Application No. 201310254851.4 filed on Jun. 24, 2013, the disclosure of which is hereby incorporated by reference herein in its entirety.

### TECHNICAL FIELD

Embodiments of the present disclosure generally relate to techniques for tagging and searching electronically stored documents.

### BACKGROUND

With the development of Internet technology, Internet applications of social network type have replaced traditional news release websites to become the mainstream. The publisher of network information resource has changed from traditional website administrator to visitors of the website. For example, in microblog applications, a user can write or edit an article to publish so as to share it with other followers; in E-commerce applications, a user also can edit a comment for goods according to his/her own experience.

However, inventors find through study that following problems exist in the conventional technology: when searching document information such as microblog or goods comments, users often need to input several key words manually and need to select proper key words according to requirements before finding expected information from a great amount of document information; therefore, for users, input steps are cumbersome and certain experience is needed to determine an exact key word, which cause a low efficiency in information retrieve.

### SUMMARY

In general, one aspect of the subject matter described in this specification can be embodied in a method of tagging documents. A plurality of electronically stored documents are combined into a group. For each of the plurality of documents in the group, a word set corresponding to the document is obtained by performing word-segmentation on the document, the obtained word set including a plurality of words contained in the document. The obtained word sets is aggregated into a subject set including a plurality of subjects, each subject including a plurality of subject words. For each of the plurality of subjects in the subject set, a subject word is selected among the plurality of subject words as an attribute word of the subject. For each of the plurality of documents in the group which contains one or more of the plurality of attribute words, the document is associated with at least a portion of the one or more attribute words. Other embodiments of this aspect include corresponding systems and computer program products.

These and other embodiments can optionally include one or more of the following features.

The aggregation can be based on Latent Dirichlet Allocation (LDA) model.

For each of the plurality of subjects in the subject set, the selection of attribute word can be based on global term frequency of the subject words in the subject,

For each of the documents in the group, the attribute words associated with the document can be selected among the one or more attribute words contained in the document based on probability information about the one or more attribute words.

For an obtained word set corresponding to a document in the group, at least a portion of the plurality of words in the word set can be filtered out based on term frequency and inverse document frequency of the words.

For a subject in the subject set, additional subject words can be appended to the subject based on HowNet Chinese word library.

For an attribute word associated with a document in the group, positive or negative emotional information corresponding to the associated attribute word can be acquired from the document based on HowNet Chinese word library and associated with the document.

The plurality of electronically stored documents to be combined into a group can be obtained by retrieving with certain type information.

The type information can be associated with the attribute words of the subjects in the subject set.

At least one stopwords corresponding to the type information can be acquired and documents including at least a portion of the stopwords can be filtered out from the plurality of documents obtained from retrieving with the type information.

Another aspect of the subject matter described in this specification can be embodied in a method of searching documents. Different groups of electronically stored documents is obtained by retrieving with different type information. For each of the document group, tagging documents in the group is performed based on the tagging method described above. For each of the type information, the type information is associated with the attribute words of the subjects in the subject set. In response to a search query, type information matched with the search query is obtained and the attribute words associated with the type information are displayed. Other embodiments of this aspect include corresponding systems and computer program products.

These and other embodiments can optionally include one or more of the following features. In response to choosing by a user one or more of the displayed attribute words, documents associated with the choosed attribute words can be displayed.

The details of one or more implementations of the subject matter are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart of a document tagging method according to some embodiments;

FIG. 2 is a display drawing of a retrieval interface according to some embodiments;

FIG. 3 is a block diagram illustrating a device for tagging documents according to some embodiments; and

FIG. 4 is a block diagram illustrating a device for tagging documents according to some other embodiments;

FIG. 5 is a flowchart of a document tagging method according to some other embodiments;

FIG. 6 is a block diagram illustrating a system for tagging documents according to some other embodiments;

FIG. 7 is a flowchart of a document searching method according to some embodiments; and

FIG. 8 is a block diagram illustrating a system for searching documents according to some embodiments.

### DETAILED DESCRIPTION

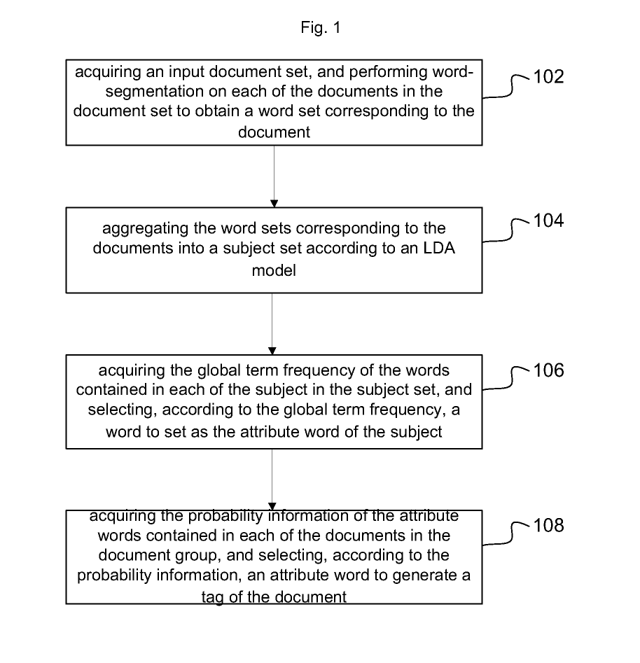

Referring to FIG. 1, which is a flowchart of a document tagging method according to some embodiments. The method shown in FIG. 1 can totally rely on a computer program, wherein the computer program can be run on a computer system based on Von Neumann architecture. The method can include the following steps S102-S108.

In Step S102: an input document group may be acquired and word-segmentation may be performed on each of the documents in the document group to obtain a word set corresponding to the document.

The document may include at least one of text information of microblog, text information of microblog comment, text information of goods comment at E-commerce website, text information of a post in a forum, text information of questions or answers to a website and so on. One document may include a microblog or a comment. The input document group may include a group consisting of documents to be clustered and to be added with tags according to the clustered subject.

In one embodiment, the step of acquiring an input document group may include: acquiring input type information and retrieving to obtain a corresponding document group according to the type information. In this embodiment, all documents may be stored in a global database. For example, microblog data may be stored in a corresponding data table in the database. The type information may include the type to which the documents to be clustered and to be added with tags belongs. For example, the type information can include several key words relevant to mobile phone. These key words can be retrieved in the data table corresponding to the microblog data after OR connection, then the retrieval result obtained is the document group corresponding to the type information “mobile phone”.

For example, in an application scene, a user can input key words such as “mobile phone”, “Xiaomi”, “iPhone”, “Blackberry” and “htc”, and then retrieve these key words in the data table in the database corresponding to microblog data after OR connection, to obtain a document group corresponding to the type information “mobile phone”.

In this embodiment, further, the step of retrieving to obtain a corresponding document group according to the type information may include: acquiring a stopword set, wherein the stopword list includes stopwords; retrieving, according to the type information, a document group matched with the type information but not containing the stopwords.

In the above example, the predetermined stopword set may include “millet porridge” (the pronunciation and spelling of millet are the same as Xiaomi in Chinese), “Apple or kilogram” and other stopwords, so as to prevent the retrieval of documents within the document group semantically irrelevant to the type information “mobile phone”.

In this embodiment, performing word-segmentation on the documents in the document group to obtain a word set corresponding to the document may include: traversing the documents in the document group and performing word-segmentation on the documents. Preferably, only segmented nouns and verbs may be extracted to obtain a word set.

For example, microblog information “mobile phone Xiaomi has a long standby time, the endurance is good” may become a word set “Xiaomi, mobile phone, standby time, endurance” after segmentation and filtering.

Step 104: Word sets corresponding to the documents may be aggregated into a subject set according to an LDA model.

The LDA model is a three-layer Bayesian probability model. The LDA model is an unsupervised machine learning technology, which can identify the subject information latent in the document group. The subject may include a set aggregated by several words obtained after clustering. A document can correspond to several subjects, that is, belong to several types. A subject can include several words, each of which has a corresponding probability.

In this embodiment, the word set corresponding to a document can be converted into the following format:

n, word1:n1, word2:n2, word3:n3 . . . ;

For example, microblog information “comparative analysis of standby time of mobile phones, mobile phone Xiaomi has 24 h of standby time, mobile phone iPhone has 24 h of standby time” becomes a word set of the following format after segmentation:

7, mobile phone:3, standby time:3, Xiaomi:1, iPhone:1 . . .

After the above conversion, the word set corresponding to each document within the document group maybe input into the LDA model. Then, through the unsupervised learning of this model, several subjects can be obtained, that is, a subject set can be obtained. Each subject corresponds to several words. And each word corresponds to a corresponding probability, which is obtained through the calculation of the LDA model.

After the subject set containing several subjects is obtained through the LDA model, traversal can be performed on the subject set to filter, through a threshold value, the words with small probability contained in the subject in this subject set. Then, each subject contains fewer words. Generally, the word with small probability has a weak correlation with the subject. The filtering of the word with small probability not only can improve processing speed but also can improve accuracy.

Further, additional words may be appended to the subject in the subject set according to the HowNet Chinese word library.

The HowNet Chinese word library refers to the HowNet base, which supplies a large number of Chinese synonyms. The words contained in the subject can be extended through synonym extension according to the HowNet library, that is, synonyms corresponding to the word contained in the subject obtained by the LDA model are acquired through the HowNet base, and then the synonyms are added in the subject. By extending the subject through the HowNet Chinese word library, the word contained in the subject can be extended semantically, and the accuracy of processing Chinese documents is improved.

Further, before the step of aggregating the word set corresponding to the document into a subject set according to the LDA model, the method may further include: acquiring the term frequency of the words and an inverse document frequency in the word set corresponding to the document; and filtering the word in the word set corresponding to the document, according to the term frequency and the inverse document frequency.

Term Frequency (TF) refers to the frequency of certain word appearing in one document or in certain number of words.

Inverse Document Frequency (IDF) refers to the proportion of the number of documents containing this word to the number of all documents. For example, if totally 10,000 comments are retrieved and 2000 comments contain the word “Xiaomi”, then the IDF value corresponding to the word “Xiaomi” is 0.2.

In this embodiment, the product of the TF value and the IDF value corresponding to a word can be calculated. If this product is less than a threshold value, this word is filtered out the word set corresponding to the document. Generally, the word with a small product of TF value and IDF value is not cared by a reader. Tthe removal of this kind of word not only can improve the processing speed but also can improve accuracy.

Step 106: global term frequency of the words contained in each of the subjects in the subject set may be acquired, and according to the global term frequency, a word may be selected to set as the attribute word of the subject.

As mentioned above, the subject contains several words, and the global term frequency of each word refers to the total times of this word appearing in the documents. In this embodiment, the word with the biggest global term frequency can be selected as the attribute word of this subject.

For example, if certain subject contains words “Xiaomi, standby time, endurance” after extension, and the word “Xiaomi” appears 10,000 times in all microblog information (when the global term frequency is obtained through accumulated statistics, if the word “Xiaomi” appears twice in certain microblog, the accumulated number of global term frequency is 2; the same below) while the word “standby time” appears 8000 times in all microblog information and the word “endurance” appears 1000 times in all microblog information, then the word “Xiaomi” may be selected as the attribute word of this subject.

Step 108: the probability information of the attribute words contained in each of the documents in the document group can be acquired, and according to the probability information, one or more attribute words may be selected, to generate a tag of the document.

A document may include the attribute words of several subjects. The probability information of attribute words of a subject refers to the proportion of the number of certain attribute word contained in a document to the number of total attribute words contained in the document. For example, in a document, the attribute word “Xiaomi” of the subject “Xiaomi” appears three times, the attribute word “standby time” of the subject “standby time” appears once, and this document contains no attribute word of other subjects, then, the probability information corresponding to “Xiaomi” is 75%, while the probability information corresponding to “standby time” is 25%.

In this embodiment, the attribute word with probability information greater than the threshold value can be taken as the tag of the document. For example, in the above example, if the threshold value is set to 20%, the tag corresponding to the document includes “Xiaomi” and “standby time”; if the threshold value is set to 30%, the tag corresponding to the document includes “Xiaomi” only.

In one embodiment, the step of selecting, according to the probability information, an attribute word to generate a tag of the document can further include: extracting positive or negative emotional information contained in the document corresponding to the selected attribute word according to the HowNet Chinese word library; generating a tag of the document according to the attribute word and the extracted corresponding positive or negative emotional information.

Here, the modifying attributive participle of the attribute word contained in the context of the document can be obtained, and then the modifying attributive participle is identified as a commendatory term or a derogatory term according to the HowNet base; if the modifying attributive participle is identified as a commendatory term, positive emotional information can be extracted; if the modifying attributive participle is identified as a derogatory term, negative emotional information can be extracted.

In this embodiment, the attribute word and the positive or negative emotional information can be mapped as a tag according to a preset mapping table. For example, if the content in a comment is “mobile phone Xiaomi is comfortable to use”, it is obtained through the above steps that the attribute word of the comment which can serve as the tag is “mobile phone Xiaomi”, and the “mobile phone Xiaomi” extracted through the HowNet base is identified as positive emotional information, then a tag “mobile phone Xiaomi is good” is generated and it is set as the tag of this comment.

In one embodiment, the input document group can be retrieved according to the input type information. Correspondingly, after the step of selecting, according to the probability information of the attribute word contained in the document in the document group, an attribute word to generate a tag of the document, a corresponding relationship may be established between the generated tag and the type information.

In this embodiment, after a tag (or tags) is (or are) added to the document in the document group, all documents contained in the document group can be traversed in the database and a corresponding relationship can be established between the document and the tag. For example, the identification of a tag corresponding to a document can be added in the tag field in the data table corresponding to the document. Also, a data table corresponding to the type information can be acquired and a tag corresponding to the type information can be added in the data table corresponding to the type information.

For example, in an application scene, type information “mobile phone”, “computer”, “notebook” and “handset” is processed in accordance with Step 102 to Step 108 respectively to obtain respective tags corresponding to the type information “mobile phone”, “computer”, “notebook” and “handset”. For example, the type information “mobile phone” might correspond to tags such as “mobile phone”, “standby time”, “endurance” and “screen size”, and the retrieved document relevant to “mobile phone” might include the above tags. For example, there can be N documents retrieved relevant to “mobile phone” containing the tag “standby time”, and M documents retrieved relevant to “mobile phone” containing the tag “endurance”. Then, a database table can be established, in which data item can be created for storing, respectively, the corresponding relationship between the type information “mobile phone”, “computer”, “notebook”, “handset” and respective corresponding tags.

Further, in this embodiment, the input key word also can be acquired and type information matched with the key word can be acquired too. The tag corresponding to the type information can be acquired and displayed. A tag selection request can be acquired and the tag corresponding to the tag selection request can be acquired. And the document containing the tag can be acquired.

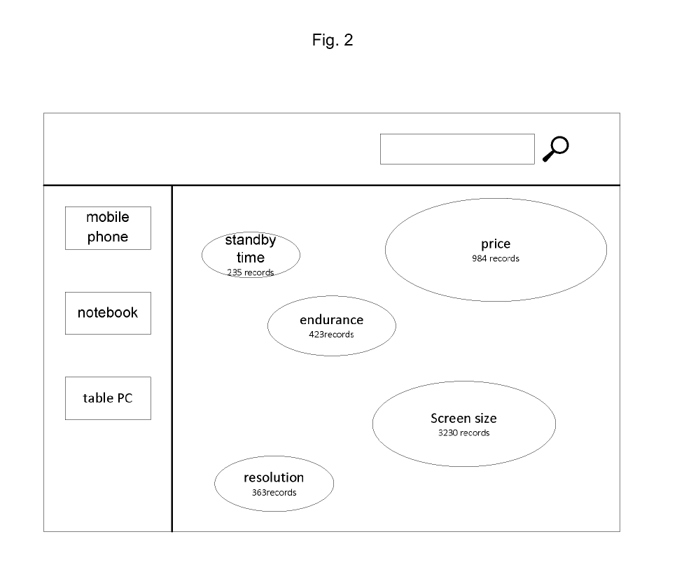

In one application scene, as shown in FIG. 2, a user can input a key word “apple” in the search box, then the type information acquired matched with “apple” might include “mobile phone”, “notebook” and “tablet PC” and it is displayed on the interface in the form of tab bars in which tags corresponding to “mobile phone”, “notebook” and “tablet PC” are displayed respectively, and the user can switch between the tab bars. If the user expects to learn microblog or comment information relevant to mobile phone and standby time, he/she can click the tag “standby time”. Then, the retrieval result page displays all microblog or comment information containing standby time.

Preferably, while a tag is displayed, the number of documents containing this tag can be displayed too. Preferably, the size of the area displaying the tag can be adjusted according to the number of documents corresponding to this tag (for example, the display area of the elliptic icon corresponding to the tag shown in FIG. 2). The display of the number of documents corresponding to a tag can facilitate a user to learn intuitively what the current hot topic is and what the important attribute of certain product is, so as to help the user make a decision, to avoid inputting cumbersome key words to search and thus to improve the operation efficiency.

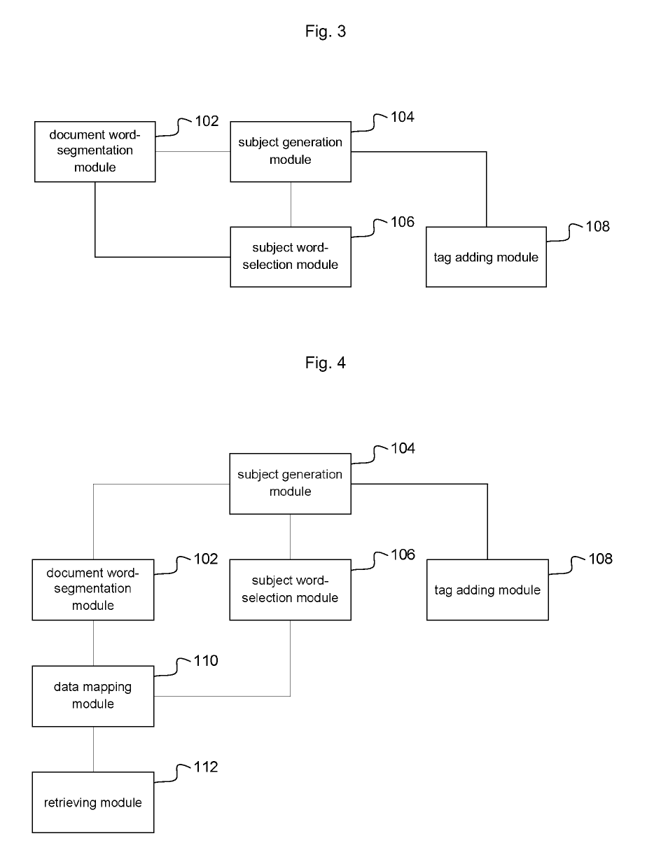

Referring to FIG. 3, which is a block diagram illustrating a device for tagging documents according to some embodiments.

The device as shown in FIG. 3 may include: a document word-segmentation module 102, which is configured to acquire an input document group and to perform word-segmentation on each document in the document group to obtain a word set corresponding to the document; a subject generation module 104, which is configured to aggregate the word setd corresponding to the documents into a subject set according to an LDA model; a subject word-selection module 106, which is configured to acquire the global term frequency of the word contained in each subject in the subject set, and to select, according to the global term frequency, a word to set as the attribute word of the subject; and a tag adding module 108, which is configured to acquire the probability information of the attribute words contained in each document in the document group, and to select, according to the probability information, an attribute word to generate a tag of the document.

In one embodiment, the document word-segmentation module 102 can be further configured to acquire the term frequency of the words in the word set corresponding to the document and an inverse document frequency, and, to filter the word in the word set corresponding to the document according to the term frequency and the inverse document frequency.

In one embodiment, the subject generation module 104 can be further configured to extend the words contained in the subject in the subject set according to the HowNet Chinese word library.

In one embodiment, the tag adding module 108 can be further configured to extract positive or negative emotional information contained in the document corresponding to the selected attribute word according to the HowNet Chinese word library, and to generate a tag of the document according to the attribute word and the extracted corresponding positive or negative emotional information.

In one embodiment, the document word-segmentation module 102 is further configured to acquire input type information and to retrieve to obtain a corresponding document group according to the type information;

In this embodiment, as shown in FIG. 4, the device can further include a data mapping module 110, which is configured to establish a corresponding relationship between the generated tag and the type information.

In one embodiment, as shown in FIG. 4, the device can further include a retrieving module 112, which is configured to acquire an input key word and type information matched with the key word, to acquire a tag corresponding to the type information and to display the tag, to acquire a tag selection request and to acquire the tag corresponding to the tag selection request, and to acquire the document containing the tag.

In one embodiment, the document word-segmentation module 102 can be further configured to acquire a stopword set, wherein the stopword list includes stopwords, and to retrieve, according to the type information, a document group matched with the type information but not containing the stopwords.

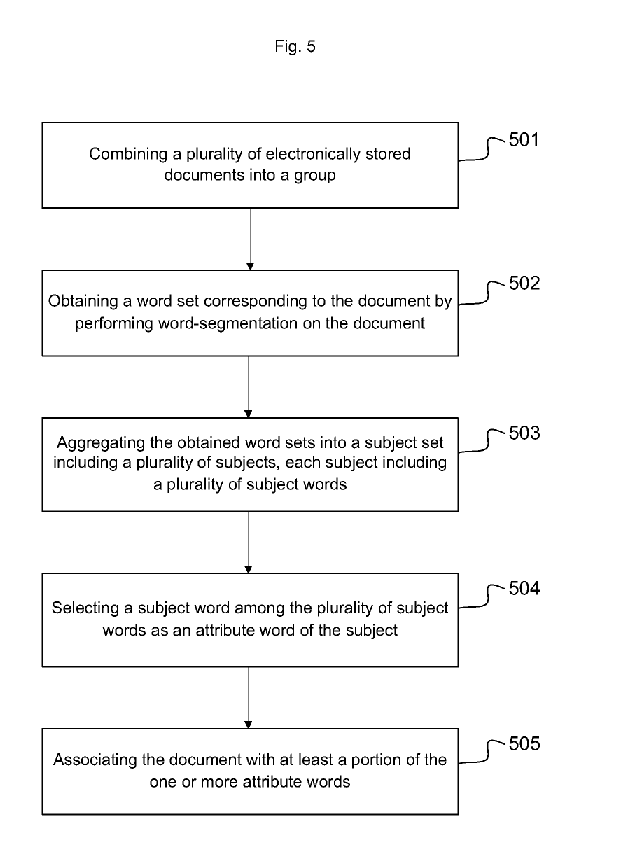

Referring to FIG. 5, which is a flowchart of a document tagging method according to some other embodiments.

In step 501, a plurality of electronically stored documents may be combined into a group.

The plurality of electronically stored documents to be combined into a group may be obtained by retrieving with certain type information.

In Step 502, for each of the plurality of documents in the group, a word set corresponding to the document may be obtained by performing word-segmentation on the document, the obtained word set including a plurality of words contained in the document.

In an example, for an obtained word set corresponding to a document in the group, at least a portion of the plurality of words in the word set can be filtered out based on term frequency and inverse document frequency of the words.

In Step 503, the obtained word sets may be aggregated into a subject set including a plurality of subjects, each subject including a plurality of subject words.

In an example, the aggregation may be performed based on Latent Dirichlet Allocation (LDA) model.

In an example, for a subject in the subject set, additional subject words may be appended to the subject based on HowNet Chinese word library.

In Step 504, for each of the plurality of subjects in the subject set, a subject word may be selected among the plurality of subject words as an attribute word of the subject.

In an example, for each of the plurality of subjects in the subject set, the selection of attribute word may be performed based on global term frequency of the subject words in the subject,

In Step 505, for each of the plurality of documents in the group which contains one or more of the plurality of attribute words, the document may be associated with at least a portion of the one or more attribute words.

In an example, for each of the documents in the group, the attribute words associated with the document may be selected among the one or more attribute words contained in the document based on probability information about the one or more attribute words.

In an example, for an attribute word associated with a document in the group, positive or negative emotional information corresponding to the associated attribute words may be acquired from the document based on HowNet Chinese word library and associated with the document.

In an example, if the plurality of electronically stored documents to be combined into a group are obtained by retrieving with certain type information, the type information may be associated with the attribute words of the subjects in the subject set.

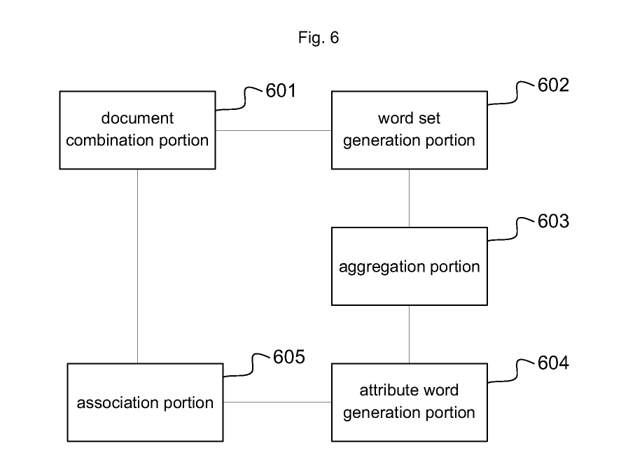

FIG. 6 is a block diagram illustrating a system for tagging documents according to some other embodiments. The system may include the device illustrated in FIGS. 3-4, and adopt the methods illustrated in FIGS. 1 and 5. For example, the system can include a document combination portion 601, a word set generation portion 602, an aggregation portion 603, an attribute word generation portion 604 and an association portion 605.

In an example, the document combination portion 601 can be configured to combine a plurality of electronically stored documents into a group.

In an example, the word set generation portion 602 can be configured to, for each of the plurality of documents in the group, obtain a word set corresponding to the document by performing word-segmentation on the document, the obtained word set including a plurality of words contained in the document.

In an example, the aggregation portion 603 can be configured to aggregate the obtain word sets into a subject set including a plurality of subjects, each subject including a plurality of subject words.

In an example, the attribute word generation portion 604 can be configured to, for each of the plurality of subjects in the subject set, select a subject word among the plurality of subject words as an attribute word of the subject.

In an example, the association portion 605 can be configured to, for each of the plurality of documents in the group which contains one or more of the plurality of attribute words, associate the document with at least a portion of the one or more attribute words.

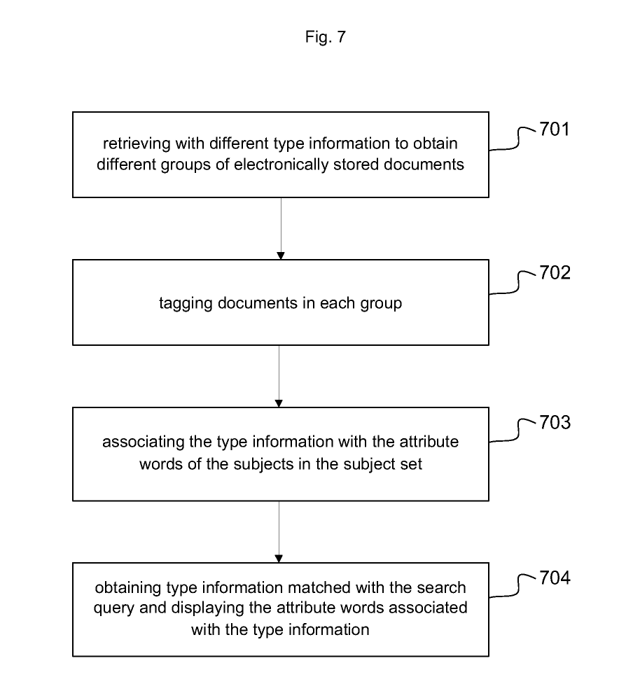

Referring to FIG. 7, which is a flowchart of a document searching method according to some embodiments.

In Step 701, different groups of electronically stored documents may be obtained by retrieving with different type information.

In Step 702, for each of the document group, documents in the group can be tagged based on the tagging method shown in FIG. 6.

In Step 703, for each of the type information, the type information can be associated with the attribute words of the subjects in the subject set.

In Step 704, in response to a search query, type information matched with the search query can be found and the attribute words associated with the type information can be displayed. In an example shown in FIG. 2, when a search query, “apple”, is input by a user through a terminal, different type information matched the search query, like “mobile phone”, “notebook” and “tablet PC”, can be obtained, and attributes words associated with each type information can also be shown.

In an example, the method may further comprising enabling a user to choose one or more of the displayed attribute words and displaying documents associated with the choosed attribute words. For example, in FIG. 2, if a user click bars to choose the attribute word ““standby time” associated with the type information “mobile phone”, documents associated with the attribute word “standby time”, 253 records associated with the attribute word “standby time” would be shown to the user.

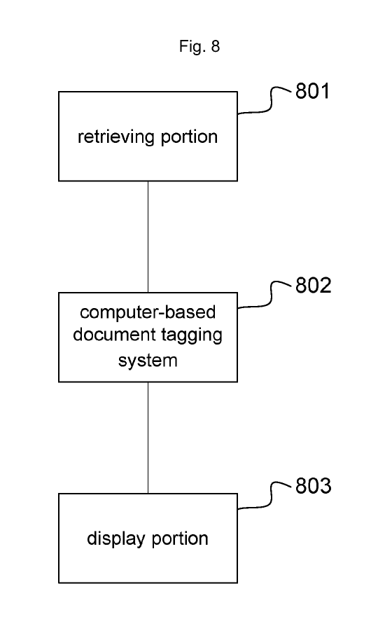

FIG. 8 is a block diagram illustrating a system for searching documents according to some embodiments. The system may include the device illustrated in FIGS. 3-4, and adopt the methods illustrated in FIGS. 1 and 5. For example, the system can include a retrieving portion 801, a computer-based document tagging system 802 and a display portion 803.

In an example, the retrieving portion 801 can be configured to retrieve with different type information to obtain different groups of electronically stored documents.

In an example, the computer-based document tagging system 802 may be implemented by the system as shown in FIG. 6. The system may be configured to, for each of the document group, tag documents in the group. In an example, the association portion 605 of the system in FIG. 6 may be further configured to, for each of the type information, associate the type information with the attribute words of the subjects in the subject set. In an example, the retrieving portion 801 may be further configured to, in response to a search query, obtain type information matched with the search query.

The display portion 803 can be configured to display the attribute words associated with the type information.

The system shown in FIG. 8 may further comprise a user interface configured to enable a user to choose one or more of the displayed attribute words, as show in FIG. 2.

The display portion 803 may be further configured to display documents associated with the choosed attribute words.

With the method and the device for tagging documents mentioned above, the word set obtained by word segmentation of documents is aggregated to obtain a subject set, wherein each subject includes several words having strong correlation; then according to the global term frequency of word, a word is selected to serve as an attribute word for the subject; and finally, according to the probability information of the attribute word contained in the document, an attribute word is selected to serve as a tag of the document, so that the document is associated with the tag; thus, during retrieve, users do not need to input key words manually, and they can find corresponding documents according to corresponding tags; therefore, the efficiency in information retrieve is improved.

The ordinary skilled in the art can understand that all or part processes in the above method embodiment can be implemented by instructing related hardware through a computer program; the program can be stored in a computer readable storage medium; the execution of the program might include the processes in the embodiment of the above methods. The storage medium can be a disk, a compact disk, a Read-Only Memory (ROM) or Random Access Memory (RAM) and the like.

All references cited in the description are hereby incorporated by reference in their entirety. While the disclosure has been described with respect to a limited number of embodiments, those skilled in the art, having benefit of this disclosure, will appreciate that other embodiments can be advised and achieved which do not depart from the scope of the description as disclosed herein.

1. A method of tagging documents, the method comprising:
combining a plurality of electronically stored documents into a group;
for each of the plurality of documents in the group, obtaining a word set corresponding to the document by performing word-segmentation on the document, the obtained word set including a plurality of words contained in the document;
aggregating the obtained word sets into a subject set including a plurality of subjects, each subject including a plurality of subject words;
for each of the plurality of subjects in the subject set, selecting a subject word among the plurality of subject words as an attribute word of the subject;
for each of the plurality of documents in the group which contains one or more of the plurality of attribute words, associating the document with at least a portion of the one or more attribute words.

2. The method of claim 1, wherein the aggregation is based on Latent Dirichlet Allocation (LDA) model,
wherein for each of the plurality of subjects in the subject set, the selection of attribute word is based on global term frequency of the subject words in the subject,

3. The method of claim 1, wherein for each of the documents in the group, the attribute words associated with the document are selected among the one or more attribute words contained in the document based on probability information about the one or more attribute words.

4. The method of claim 1, wherein the method further comprises at least one of the following:
for an obtained word set corresponding to a document in the group, filtering out at least a portion of the plurality of words in the word set based on term frequency and inverse document frequency of the words;
for a subject in the subject set, appending additional subject words to the subject based on HowNet Chinese word library; or
for an attribute word associated with a document in the group, acquiring from the document positive or negative emotional information corresponding to the associated attribute word based on HowNet Chinese word library and associating the document with the acquired positive or negative emotional information.

5. The method of claim 1, further comprising:
retrieving with certain type information to obtain the plurality of electronically stored documents to be combined into a group; and,
associating the type information with the attribute words of the subjects in the subject set.

6. The method of claim 5, further comprising:
acquiring at least one stopwords corresponding to the type information;
filtering out, documents including at least a portion of the stopwords, from the plurality of documents obtained from retrieving with the type information.

7. (canceled)

8. (canceled)

9. A computer-based document tagging system comprising:
a document combination portion configured to combine a plurality of electronically stored documents into a group;
a word set generation portion configured to, for each of the plurality of documents in the group, obtain a word set corresponding to the document by performing word-segmentation on the document, the obtained word set including a plurality of words contained in the document;
an aggregation portion configured to aggregate the obtain word sets into a subject set including a plurality of subjects, each subject including a plurality of subject words;
an attribute word generation portion configured to, for each of the plurality of subjects in the subject set, select a subject word among the plurality of subject words as an attribute word of the subject;
an association portion configured to, for each of the plurality of documents in the group which contains one or more of the plurality of attribute words, associate the document with at least a portion of the one or more attribute words.

10. The system of claim 9, further comprising:
a retrieving portion configured to retrieve with certain type information to obtain the plurality of electronically stored documents to be combined into a group,
wherein the association portion is further configured to associate the type information with the attribute words of the subjects in the subject set.

11. (canceled)

12. (canceled)

13. A non-transitory computer readable storage medium including instructions that, when executed by a processor, cause the processor to perform a method according to claim 1.

14. A non-transitory computer readable storage medium including instructions that, when executed by a processor, cause the processor to perform a method according claim 2.

15. A non-transitory computer readable storage medium including instructions that, when executed by a processor, cause the processor to perform a method according claim 3.

16. A non-transitory computer readable storage medium including instructions that, when executed by a processor, cause the processor to perform a method according claim 4.

17. A non-transitory computer readable storage medium including instructions that, when executed by a processor, cause the processor to perform a method according claim 5.

18. A non-transitory computer readable storage medium including instructions that, when executed by a processor, cause the processor to perform a method according claim 6.
